(19) United States
(12) Patent Application Publication
(10) Pub. No.: US 2004/0068569 A1
(43) Pub. Date: Apr. 8, 2004

(54) System and method for identifying portable devices by a web server

(76) Inventors: Mavis Liao, Hsin-Tien City (TW); Eric Yeh, Hsin-Tien City (TW); Teng-Hsu Lee, Hsin-Tien City (TW)

Correspondence Address: RABIN & Berdo, PC, 1101 14TH STREET, NW, SUITE 500, WASHINGTON, DC, 20005, US

(21) Appl. No.: 10/235,717

(22) Filed: Sep. 6, 2002

(51) Int. Cl. G06F 15/16; G06F 15/177

(52) U.S. Cl. 709/228; 709/203

(57) ABSTRACT

A system and method for identifying portable devices by a web server. The system includes a portable device and a web server. When web service is desired, at least one unique identifying characteristic of the portable device is acquired and included into the header of a HTTP packet, and the packet is sent to a web server. The packet is received by the web server through a network, and the unique identifying characteristics of the portable device are acquired from the header of the packet. Further, the production date and specifications of the portable device are acquired by querying a database according to the unique identifying characteristics on the web server.

### BACKGROUND OF THE INVENTION

1. Field of the Invention

The present invention relates to a system and method for identifying portable devices by a web server, and particularly to a system and method that integrates at least one unique identifying characteristic into the header of a HTTP packet to recognize specific portable devices.

2. Description of the Related Art

With the rise of the Internet, a variety of web services has been developed and is provided to users via network. At the same time, portable devices, such as smart phones and handheld PCs providing access to web services via wireless network has become a popular trend.

In current practice, users have to register user identification and password on the web server before accessing web services. It is complicated to use, and the information may be forgotten or misused when transferring through the network.

For some specific services, such as software update of portable devices, since there is no effective mechanism to automatically identify portable devices by web servers, it is difficult for users to identify the version of the portable devices and select appropriate software for update.

### SUMMARY OF THE INVENTION

It is therefore an object of the present invention to provide a system and method for identifying portable devices by a web server that integrates at least one unique identifying characteristic into the header of a HTTP packet to recognize specific portable devices.

To achieve the above objects, the present invention provides a system and method for identifying portable devices by a web server. According to one embodiment of the invention, the system for identifying portable devices by a web server includes a portable device and a web server.

The portable device supports an application, which, when web service is desired, acquires at least one unique identifying characteristic of the portable device and includes it into the header of a HTTP packet, and then the portable device sends the packet to a web server providing the web service.

The web server receives the packet through a network, and then accesses the unique identifying characteristics of the portable device from the header of the packet. Further, the web server queries a database to acquire the production date and specifications of the portable device according to the unique identifying characteristics.

According to another embodiment of the invention, a method for identifying portable devices by a web server is provided. First, at least one unique identifying characteristic of a portable device is acquired, and the unique identifying characteristics are inserted into a header of a HTTP packet. Then, the packet is sent to a web server by the portable device.

Thereafter, the packet is received by the web server through a network, and the unique identifying characteristics of the portable device are acquired from the header of the packet. Similarly, the production date and specifications of the portable device are acquired by querying a database according to the unique identifying characteristics on the web server.

The network may be a fixed network or a wireless network. Furthermore, the portable device may be a smart phone or a handheld PC. The unique identifying characteristics are the IMEAI (International Mobile Equipment Identity) of the smart phone, or comprise CPU identification, BIOS identification and NIC (Network Interface Card) identification of the handheld PC.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram showing the architecture of the system for identifying portable devices by a web server according to the embodiment of the present invention;

FIG. 2 is a schematic diagram showing the HTTP packet; and

FIG. 3 is a flowchart illustrating the method for identifying portable devices by a web server according to the embodiment of the present invention.

### DETAILED DESCRIPTION OF THE INVENTION

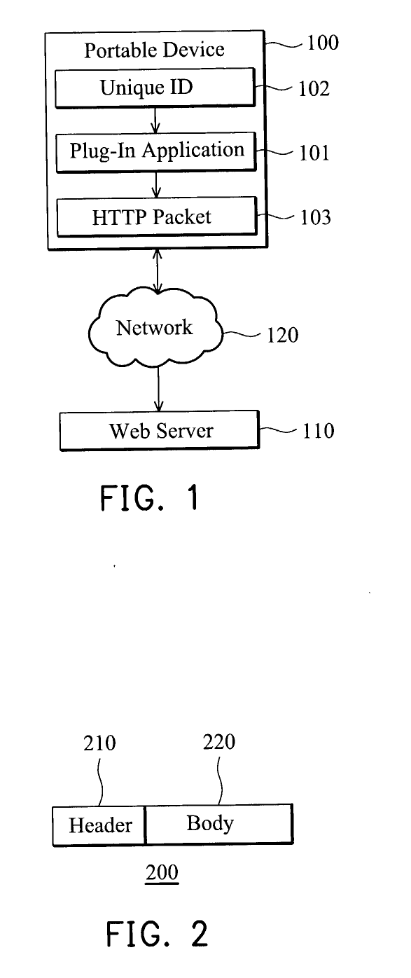

FIG. 1 is a schematic diagram showing the architecture of the system for identifying portable devices by a web server according to the embodiment of the present invention.

According to the embodiment of the invention, the system for identifying portable devices by a web server includes a portable device 100 and a web server 110.

The portable device 100 supports an application 101. Note that the application 101 may be plug-in software on the browser (not shown) in the portable device 100. When web service is desired, the application 101 acquires at least one unique identifying characteristic 102 of the portable device 100 accompanying the browser. It should be noted that the portable device 100 may be a smart phone or a handheld PC. The unique identifying characteristics 102 may be the IMEAI (International Mobile Equipment Identity) of the smart phone, or may comprise CPU (Central Processing Unit) identification, BIOS (Basic Input/Output System) identification and NIC (Network Interface Card) identification of the handheld PC.

Then, the application 101 includes the unique identifying characteristics 102 into the header of a packet 103. The packet 103 conforms to the HTTP (HyperText Transmission Protocol) protocol. FIG. 2 is a schematic diagram showing the HTTP packet 200. The HTTP packet 200 comprises header 210 and body 220. The header 210 records instructions or URL (Uniform Resource Locator) information, and the body 220 records the content or data. Thereafter, the portable device 100 sends the HTTP packet to a web server 110 providing the web service.

The web server 110 receives the packet 103 through a network 120. The network 120 may be a fixed network or a wireless network. The web server 110 then acquires the unique identifying characteristics 102 of the portable device 100 from the header of the packet 103.

Further, the web server 110 may have a database (not shown) recording the production date and specifications of portable devices. The web server 110 may query the database to acquire the production date and specifications of the portable device 100 according to the unique identifying characteristics, so as to prepare appropriate software for update or other applications.

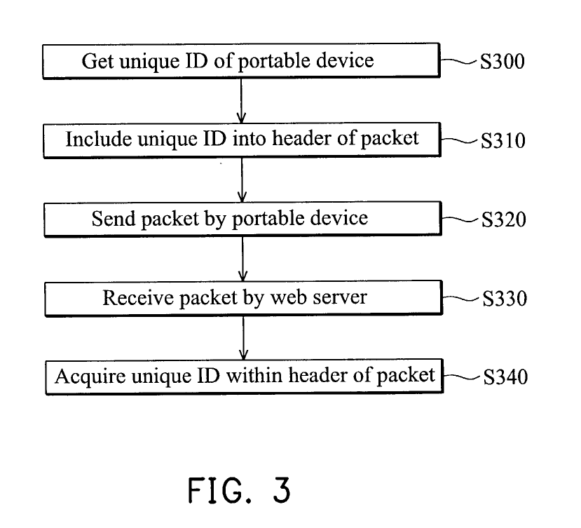

FIG. 3 is a flowchart illustrating the method for identifying portable devices by a web server according to the embodiment of the present invention.

According to the embodiment of the invention, a method for identifying portable devices by a web server is provided. First, in Step S300, at least one unique identifying characteristic of a portable device is acquired, and in Step S310, the unique identifying characteristics are inserted into the header of a HTTP packet. Then, in Step S320, the HTTP packet is sent to a web server by the portable device.

Similarly, the portable device may be a smart phone or a handheld PC. The unique identifying characteristics may be the IMEAI (International Mobile Equipment Identity) of the smart phone, or may comprise CPU (Central Processing Unit) identification, BIOS (Basic Input/Output System) identification and NIC (Network Interface Card) identification of the handheld PC.

Thereafter, in Step S330, the HTTP packet is received by the web server through a network. The network may be a fixed network or a wireless network. Finally, in Step S340, the unique identifying characteristics of the portable device are acquired from the header of the HTTP packet. Further, the production date and specifications of the portable device are acquired by querying a database according to the unique identifying characteristics on the web server.

As a result, using the system and method for identifying portable devices by a web server according to the present invention, specific portable devices can be recognized by acquiring the unique identifying characteristics from within the header of a HTTP packet.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system for identifying portable devices by a web server, comprising:
a portable device supporting an application that sends a packet comprising a header including at least one unique identifying characteristic of the portable device; and
a web server to receive the packet through a network, and acquire the unique identifying characteristics of the portable device from the header of the packet.

2. The system as claimed in claim 1 wherein the web server further queries a database to acquire the production date and specifications of the portable device according to the unique identifying characteristics.

3. The system as claimed in claim 1 wherein the packet conforms to HTTP protocol.

4. The system as claimed in claim 1 wherein the network is a fixed network.

5. The system as claimed in claim 1 wherein the network is a wireless network.

6. The system as claimed in claim 1 wherein the portable device is a smart phone.

7. The system as claimed in claim 6 wherein the unique identifying characteristic is the IMEAI (International Mobile Equipment Identity) of the smart phone.

8. The system as claimed in claim 1 wherein the portable device is a handheld PC.

9. The system as claimed in claim 8 wherein the unique identifying characteristic is the CPU (Central Processing Unit) identification of the handheld PC.

10. The system as claimed in claim 8 wherein the unique identifying characteristic is the BIOS (Basic Input/Output System) identification of the handheld PC.

11. The system as claimed in claim 8 wherein the unique identifying characteristic is the NIC (Network Interface Card) identification of the handheld PC.

12. A method for identifying portable devices by a web server, comprising the steps of:
acquiring at least one unique identifying characteristic of a portable device;
including the unique identifying characteristics into a header of a packet;
sending the packet by the portable device;
receiving the packet by a web server through a network; and
acquiring the unique identifying characteristics of the portable device from the header of the packet on the web server.

13. The method as claimed in claim 12 further querying a database to acquire the production date and specifications of the portable device according to the unique identifying characteristics on the web server.

14. The method as claimed in claim 12 wherein the packet conforms to the HTTP protocol.

15. The method as claimed in claim 12 wherein the network is a fixed network.

16. The method as claimed in claim 12 wherein the network is a wireless network.

17. The method as claimed in claim 12 wherein the portable device is a smart phone.

18. The method as claimed in claim 17 wherein the unique identifying characteristic is the IMEAI (International Mobile Equipment Identity) of the smart phone.

19. The method as claimed in claim 12 wherein the portable device is a handheld PC.

20. The method as claimed in claim 19 wherein the unique identifying characteristic is the CPU (Central Processing Unit) identification of the handheld PC.

21. The method as claimed in claim 19 wherein the unique identifying characteristic is the BIOS (Basic Input/Output System) identification of the handheld PC.

22. The method as claimed in claim 19 wherein the unique identifying characteristic is the NIC (Network Interface Card) identification of the handheld PC.
